(19) United States
(12) Patent Application Publication
(10) Pub. No.: US 2025/0247733 A1
(43) Pub. Date: Jul. 31, 2025

(54) MEASUREMENT FEEDBACK PROCESSING METHOD AND APPARATUS, TERMINAL, AND NETWORK-SIDE DEVICE

(71) Applicant: VIVO MOBILE COMMUNICATION CO., LTD., Dongguan (CN)

(72) Inventor: Yuan SHI, Dongguan (CN)

(21) Appl. No.: 19/059,452

(22) Filed: Feb. 21, 2025

Related U.S. Application Data
(63) Continuation of application No. PCT/CN2023/113219, filed on Aug. 16, 2023.

(30) Foreign Application Priority Data
Aug. 23, 2022 (CN) 202211015297.X

(51) Int. Cl. H04W 24/10; H04B 17/318

(52) U.S. Cl. CPC H04W 24/10; H04B 17/318

(57) ABSTRACT

A measurement feedback processing method includes: a first device sends first information to a second device, where the first information is used to determine at least one of the following of a measurement report: measurement feedback function information indicating a measurement report type; a first quantity; and a second quantity, where the measurement report type includes any one of the following: a normal measurement report, a prediction measurement report, and an enhanced measurement report, the first quantity is determined based on a measurement report configuration.

### CROSS-REFERENCE TO RELATED APPLICATIONS

This application is a bypass continuation application of International Application No. PCT/CN2023/113219, filed on Aug. 16, 2023, which claims the benefit of and priority to Chinese Patent Application No. 202211015297.X, filed on Aug. 23, 2022. The foregoing applications are incorporated by reference in their entireties herein.

### TECHNICAL FIELD

This application relates to the field of communications technologies and, more specifically, to a measurement feedback processing method and apparatus, a terminal, and a network side device.

### BACKGROUND

With the development of communications technology, an artificial intelligence (AI) model has been introduced for beam prediction in a communication system. When the artificial intelligence model is utilized for beam prediction, in a measurement reporting process, a measurement report type of a measurement report fed back by a terminal may be a normal measurement report, a prediction measurement report for beam prediction, or an enhanced measurement report. A quantity of information corresponding to a reference signal and/or a quantity of channel quality information may vary with different measurement report types. As a result, a network side device may not accurately understand or interpret the measurement report sent by the terminal.

### BRIEF SUMMARY

Embodiments of this application provide a measurement feedback processing method and apparatus, a terminal, and a network side device, which can resolve a problem that when artificial intelligence is introduced for beam prediction, a network side device may not accurately understand a measurement report sent by a terminal.

According to a first aspect, a measurement feedback processing method is provided, and includes:

A first device sends first information to a second device, where the first information is used to determine association information of a measurement report, and the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

According to a second aspect, a measurement feedback processing method is provided, and includes:

A second device receives first information from a first device; and
the second device determines association information of a measurement report according to the first information, where the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

According to a third aspect, a measurement feedback processing apparatus is provided, and includes:
a first sending module, configured to send first information to a second device, where the first information is used to determine association information of a measurement report, and the association information includes at least one of the following: measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

According to a fourth aspect, a measurement feedback processing apparatus is provided, and includes:
a second receiving module, configured to receive first information from a first device; and
a second sending module, configured to determine association information of a measurement report according to the first information, where the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

According to a fifth aspect, a terminal is provided. The terminal includes a processor and a memory, the memory stores a program or an instruction that is executable on the processor, and the program or the instruction is executed by the processor to implement the steps of the method according to the first aspect.

According to a sixth aspect, a terminal is provided, and includes a processor and a communication interface.

When the terminal is a first device, the communication interface is configured to send first information to a second device, where the first information is used to determine association information of a measurement report, and the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

Alternatively, when the terminal is a second device, the communication interface is configured to receive first information from a first device; and determine association information of a measurement report according to the first information, where the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

According to a seventh aspect, a network side device is provided. The network side device includes a processor and a memory, the memory stores a program or an instruction that is executable on the processor, and the program or the instruction is executed by the processor to implement the steps of the method according to the second aspect.

According to an eighth aspect, a network side device is provided, and includes a processor and a communication interface.

When the network side device is a first device, the communication interface is configured to send first information to a second device, where the first information is used to determine association information of a measurement report, and the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

Alternatively, when the network side device is a second device, the communication interface is configured to receive first information from a first device; and determine association information of a measurement report according to the first information, where the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

According to a ninth aspect, a communication system is provided, and includes a first device and a second device. The first device may be configured to perform the steps of the measurement feedback processing method according to the first aspect, and the second device may be configured to perform the steps of the measurement feedback processing method according to the second aspect.

According to a tenth aspect, a readable storage medium is provided. The readable storage medium stores a program or an instruction, and the program or the instruction is executed by a processor to implement the steps of the method according to the first aspect or the steps of the method according to the second aspect.

According to an eleventh aspect, a chip is provided. The chip includes a processor and a communication interface. The communication interface is coupled to the processor, and the processor is configured to run a program or an instruction to implement the steps of the method according to the first aspect or implement the steps of the method according to the second aspect.

According to a twelfth aspect, a computer program/program product is provided. The computer program/program product is stored in a storage medium, and the computer program/program product is executed by at least one processor to implement the steps of the method according to the first aspect or implement the steps of the method according to the second aspect.

### BRIEF DESCRIPTION OF DRAWINGS

FIG. 1 is a structural diagram of a network system to which the embodiments of this application may be applied;

FIG. 2 is a schematic diagram of a structure of a neuron;

FIG. 3 is a first schematic diagram of an AI model to which the embodiments of this application may be applied;

FIG. 4 is a second schematic diagram of an AI model to which the embodiments of this application may be applied;

FIG. 5 is a third schematic diagram of an AI model to which the embodiments of this application may be applied;

FIG. 6 is a first schematic flowchart of a measurement feedback processing method according to an embodiment of this application;

FIG. 7 is a second schematic flowchart of a measurement feedback processing method according to an embodiment of this application;

FIG. 8 is a first structural diagram of a measurement feedback processing apparatus according to an embodiment of this application;

FIG. 9 is a second structural diagram of a measurement feedback processing apparatus according to an embodiment of this application;

FIG. 10 is a structural diagram of a communication device according to an embodiment of this application;

FIG. 11 is a structural diagram of a terminal according to an embodiment of this application; and

FIG. 12 is a structural diagram of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the NR terminology is used in most of the following description, although these technologies can also be applied to applications other than the NR system application, such as the 6^{th} generation (6G) communication system.

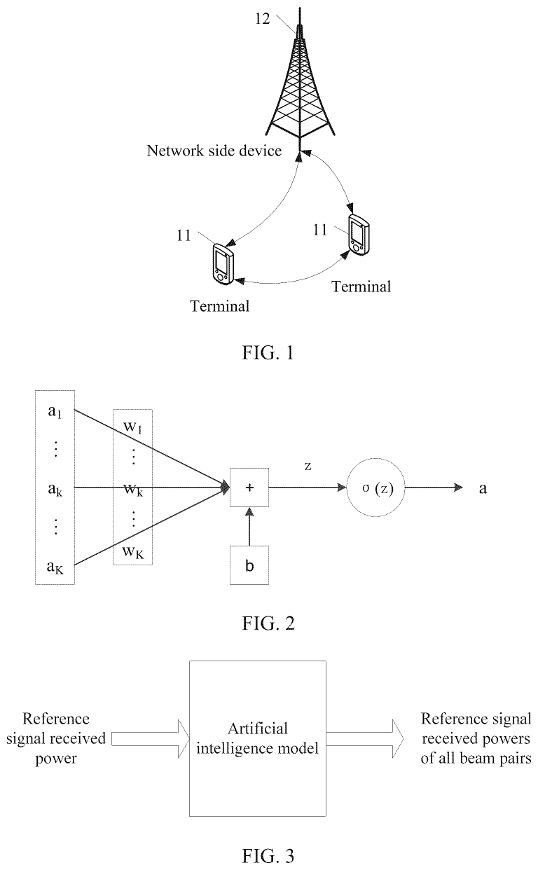

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (Basic Service Set, BSS), an extended service set (ESS), a home NodeB, a home evolved NodeB, a transmitting receiving point (TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited.

For ease of understanding, some content involved in the embodiments of this application is described below.

### 1. Artificial Intelligence

Currently, artificial intelligence is widely applied in various fields. An AI module has multiple implementations, such as a neural network, a decision tree, a support vector machine, and a Bayes classifier. In this application, the neural network is used as an example for description, but a specific type of the AI module is not limited.

The neural network includes a neuron, and a schematic diagram of the neuron is shown in FIG. 2. z=a₁*w₁+ . . . +a₁*w₁+ . . . +aₖ*wₖ+b, where a₁, a₂, . . . , a_{K} are inputs, w is a weight (also referred to as a multiplicative coefficient), b is a bias (also referred to as an additive coefficient), and σ(·) is an activation function. Common activation functions include an S function (Sigmoid), a hyperbolic tangent function (tanh), a rectified linear unit (ReLU) function, and the like.

Parameters of the neural network are optimized by using an optimization algorithm. The optimization algorithm is an algorithm that can minimize or maximize an objective function (also referred to as a loss function sometimes). The objective function is often a mathematical combination of a model parameter and data. For example, data X and its corresponding label Y are given, and a neural network model f(·) is constructed. With the model, a predicted output f(x) can be obtained according to an input x, and a difference (f(x)−Y) between a predicted value and an actual value can be calculated, which is the loss function. The purpose is to find appropriate w and b so that a value of the loss function reaches a minimum. A smaller loss value indicates that the model is closer to a real situation.

Currently, common optimization algorithms are basically based on an error back propagation (BP) algorithm. A basic idea of the BP algorithm is that a learning process consists of two processes: signal forward propagation and error back propagation. During forward propagation, an input sample is transferred from an input layer to an output layer after being processed by each hidden layer. If an actual output of the output layer does not match an expected output, error back propagation is performed. Error back propagation is to transmit an output error layer by layer to the input layer through a hidden layer in some form for back propagation, and allocate the error to all units of each layer, to obtain an error signal of a unit at each layer. This error signal is used as a basis for correcting a weight of each unit. A weight adjustment process of each layer during signal forward propagation and error back propagation is carried out repeatedly. A process of continuously adjusting a weight is a learning and training process of a network. This process continues until errors output by the network are reduced to an acceptable level or until a preset quantity of learning times are reached.

The common optimization algorithms include gradient descent, stochastic gradient descent (SGD), mini-batch gradient descent, momentum, stochastic gradient descent with momentum (which may also be referred to as Nesterov), adaptive gradient descent (Adagrad), adaptive delta (Adadelta), root mean square prop (RMSprop), and adaptive moment estimation (Adam).

During error back propagation, in these optimization algorithms, an error/loss is obtained according to the loss function, a gradient is obtained by calculating a derivative/partial derivative of a current neuron and adding a learning rate and a previous gradient/derivative/partial derivative, and the gradient is transferred to an upper layer.

### 2. Beam Indication Mechanism

After beam measurement and beam reporting are performed, the network side device may perform beam indication on downlink and uplink channels or reference signals, to establish a beam link between the network side device and the terminal, thereby implementing transmission of channels or reference signals.

For a beam indication of a physical downlink control channel (PDCCH), the network side device uses radio resource control (RRC) signaling to configure K transmission configuration indication (TCI) states for each control resource set (CORESET). When K>1, a medium access control control element (MAC CE) indicates or activates one TCI state. When K=1, no additional MAC CE command is required. When monitoring the PDCCH, the terminal monitors the PDCCH by using same quasi-colocation (QCL), that is, a same TCI state, for all search spaces in the CORESET. A reference signal and a terminal-specific (UE-specific) PDCCH demodulation reference signal (DMRS) port in the TCI state are spatial QCL. The terminal may learn of, according to the TCI state, a specific receive beam for receiving the PDCCH. The reference signal in the TCI state may be a periodic channel state information reference signal (CSI-RS), a semi-persistent CSI-RS, a synchronization signal block (SSB), or the like.

For a beam indication of a physical downlink shared channel (PDSCH), the network side device configures M TCI states by using RRC signaling, activates 2N TCI states by using a MAC CE command, and then notifies a TCI state by using an N-bit TCI field of downlink control information (DCI), where a reference signal in the TCI state and a DMRS port of the PDSCH to be scheduled are QCL. The UE may learn of, according to the TCI state, a specific receive beam for receiving the PDSCH.

For a beam indication of a CSI-RS, when a CSI-RS type is a periodic CSI-RS, the network side device configures QCL information for a CSI-RS resource by using RRC signaling. When a CSI-RS type is a semi-persistent CSI-RS, the network side device activates a CSI-RS resource from an RRC-configured CSI-RS resource set by using a MAC CE command, to indicate its QCL information. When a CSI-RS type is an aperiodic CSI-RS, the network side device configures QCL for a CSI-RS resource by using RRC signaling, and triggers a CSI-RS by using DCI.

For a beam indication of a physical uplink control channel (PUCCH), the network side device configures spatial relation information for each PUCCH resource by using RRC signaling and a parameter PUCCH-SpatialRelationInfo, and when multiple pieces of spatial relation information are configured for the PUCCH resource, one piece of spatial relation information is indicated or activated by using a MAC-CE. When only one piece of spatial relation information is configured for the PUCCH resource, no additional MAC CE command is required.

For a beam indication of a physical uplink shared channel (PUSCH), spatial relation information of the PUSCH is used when DCI carried on a PDCCH schedules the PUSCH, each SRI codepoint of a sounding reference signal resource indicator (SRI) field in the DCI indicates one SRI, and the SRI indicates the spatial relation information of the PUSCH.

For a beam indication of a sounding reference signal (SRS), when an SRS type is a periodic SRS, the network side device configures spatial relation information for an SRS resource by using RRC signaling. When an SRS type is a semi-persistent SRS, the network side device activates one piece of spatial relation information from a group of pieces of RRC-configured spatial relation information by using a MAC CE command. When an SRS type is an aperiodic SRS, the network side device configures spatial relation information for an SRS resource by using RRC signaling.

For further improvement of the beam indication, a unified TCI indication is proposed. In simple terms, subsequent reference signals and beam information of multiple channels are indicated by using a TCI field in DCI.

Optionally, beam information, the spatial relation information, spatial domain transmission filter information, spatial filter information, TCI state information, QCL information, the QCL parameter, the beam association relationship, and the like mentioned in this application have approximately the same meaning.

Downlink beam information may usually be indicated by the TCI state information or the QCL information. Uplink beam information may usually be indicated by the spatial relation information.

### 3. Beam Measurement and Beam Reporting

Analog beamforming is transmission in full bandwidth, and each polarization direction array element on a panel of each high-frequency antenna array can only send an analog beam through time division multiplexing. A weighting value of the analog beam is implemented by adjusting a parameter of a device such as a radio frequency front-end phase shifter.

In current academia and industry, a polling method is usually used to train analog beamforming vectors. To be specific, array elements of each antenna panel in each polarization direction sequentially send a training signal (that is, a candidate beamforming vector) at an appointed time in a time division multiplexing mode, and a terminal feeds back a beam report after measurement, so that a network side device can use the training signal to implement simulated beam transmission during a next service transmission. Content of the beam report usually includes several optimal transmit beam identifiers and a measured receive power of each transmit beam.

During beam measurement, the network side device configures a reference signal resource set (RS resource set), including at least one reference signal resource, such as an SSB resource or a CSI-RS resource. User equipment (UE) measures a layer 1 reference signal received power (L1-RSRP)/layer 1 signal to interference plus noise ratio (L1-SINR) of each RS resource, and reports at least one optimal measurement result to the network side device. Reported content includes a synchronization signal block resource indicator (SSBRI) or a channel state information reference signal resource indicator (CRI), and an L1-RSRP/L1-SINR. The reported content reflects at least one optimal beam and its quality for the network side device to determine a beam used to send a channel or a signal to the terminal.

When a feedback report of the terminal includes only one L1-RSRP, a 7-bit quantization method is used, a quantization step is 1 dB, and a quantization range is −140 dBm to −44 dBm. When an indicated feedback report of the terminal includes multiple L1-RSRPs, or a group-based beam report is enabled, 7-bit quantization is used for strongest RSRP quantization, a 4-bit differential quantization method is used for remaining RSRP quantization, and a quantization step is 2 dB.

Optionally, a quantity of feedback reports is determined based on a parameter configured by the network side device for the terminal, and quantities of RSs and RSRPs that should be included in the feedback report of the terminal are configured by using an RRC configuration parameter. A value of a quantity configuration is 1, 2, 3, or 4, and a default value is 1. In addition, this quantity limit is based on a capability of the terminal, and the terminal first reports a maximum quantity that can be supported.

### 4. Beam Prediction by Using an AI Method

One possible method is shown in FIG. 3, RSRPs of some beam pairs are used as an input, and an output of an AI model is an RSRP result of all beam pairs. A beam pair includes a transmit beam and a receive beam. An input quantity of the AI model is a quantity of some beam pairs that are selected, and an output quantity is a quantity of all the beam pairs.

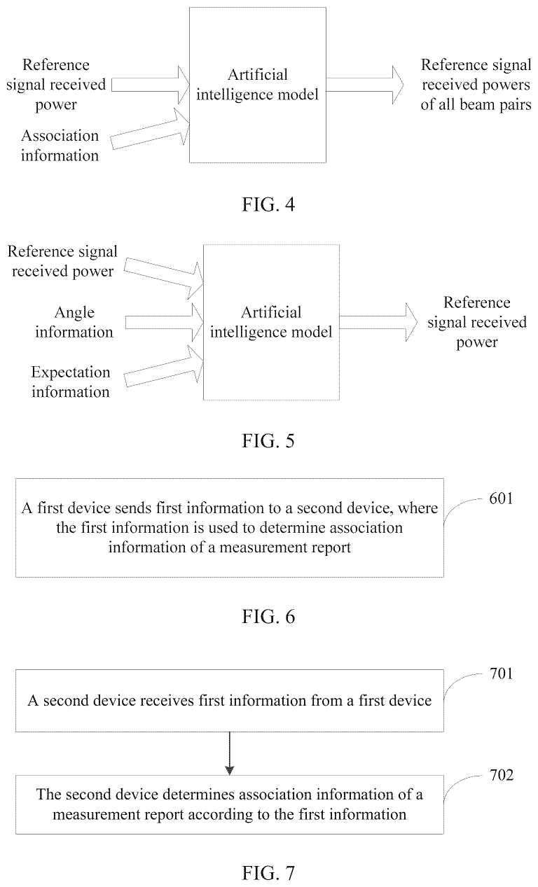

In addition, there is a method for enhancing beam prediction performance. As shown in FIG. 4 below, association information is added to an input side. The association information is usually selected for inputting angle-related information, beam identifier (ID) information, and the like corresponding to a beam pair. Therefore, the input quantity of the model is still related to the quantity of some beam pairs that are selected, and the output quantity is still equal to the quantity of all the beam pairs.

There is further an improved method that is based on the foregoing description, as shown in FIG. 5. The method mainly affects an output of an AI model by changing expectation information of the AI model.

An input type of the AI model includes at least one of the following:
beam quality-related information;
association information related to a beam;
association information related to a transmit beam of a transmitting end;
association information related to a receive beam of the receiving end;
association information related to an expected beam of the receiving end;
association information related to a receive beam, of the receiving end, expected by the receiving end;
association information related to a transmit beam, of the transmitting end, expected by the receiving end;
time-related information of the beam quality-related information; and expected prediction time-related information.

The association information related to the beam is association information corresponding to the beam, and the association information includes but is not limited to at least one of the following: beam ID-related information, beam angle-related information, beam gain-related information, beam width-related information, and the like.

When the AI model is applied, there are the following cases:

In a possible procedure, in a case that the AI model is located on a terminal side, a terminal obtains at least one optimal beam based on AI model prediction, and the terminal feeds back the at least one predicted optimal beam. In this case, after receiving feedback information, a base station configures and sends the at least one predicted optimal beam according to the feedback information. After receiving the at least one predicted optimal beam, the terminal performs measurement, and feeds back a measurement result. Therefore, there are two feedback manners. One is prediction feedback, and a predicted value is fed back. The other is normal measurement feedback, which is a measurement feedback manner that is based on a related technology.

In another possible procedure, in a case that the AI model needs model training, performance monitoring, feedback of a measurement result for prediction, and other behaviors, a feedback report usually needs to include a large quantity of measurement results. Herein, there are also two feedback manners. One is a measurement feedback manner that is based on a related technology, that is, normal measurement feedback. The other is that a feedback report needs to include a large quantity of measurement results, that is, enhanced measurement feedback.

Optionally, the feedback report may be referred to as a measurement report.

In other words, when the AI model is introduced for beam prediction, there may be three feedback behaviors, that is, the normal measurement feedback, the prediction feedback, and the enhanced measurement feedback. However, a current feedback mechanism is the normal measurement feedback. Therefore, after the AI model is introduced for beam prediction, the feedback mechanism needs to be redefined, so that the network side device can accurately understand the feedback report sent by the terminal. Therefore, a measurement feedback processing method in this application is proposed.

With reference to the accompanying drawings, the following describes in detail the measurement feedback processing method provided in the embodiments of this application by using some embodiments and application scenarios thereof.

Refer to FIG. 6. An embodiment of this application provides a measurement feedback processing method. As shown in FIG. 6, the measurement feedback processing method includes the following step:

Step 601: A first device sends first information to a second device, where the first information is used to determine association information of a measurement report, and the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

In this embodiment of this application, the normal measurement report may be understood as a regular measurement report, for example, reporting information corresponding to the first one or more reference signals and/or channel quality information in descending order of measurement results based on a last measurement result.

The prediction measurement report may be understood as a measurement report fed back after beam prediction is performed based on a measurement result. A beam corresponding to the beam prediction may include a beam besides a corresponding beam configured for measurement. For example, a network side device configures beams for measurement as a beam 1 to a beam 10 (that is, measurement beams associated with the measurement report). After measurement, predicted beams are the beam 1 to a beam 256, and a beam fed back finally is a 20^{th} beam. In other words, the information corresponding to the reference signal in the measurement report may not be included in information corresponding to a reference signal of the measurement beam associated with the measurement report. Optionally, the beam prediction may be understood as beam prediction using an AI model. For example, a result of the beam prediction may be obtained by inputting the measurement result into the AI model.

The enhanced measurement report may be understood as enhancement of the measurement report. The enhanced measurement report is equivalent to adding a quantity of feedback information to the measurement report. For example, in some embodiments, in a case of periodic measurement, feedback information corresponding to measurement results of multiple periodicities may be included. The feedback information includes at least one of the information corresponding to the reference signal and the channel quality information.

In this embodiment of this application, measurement includes but is not limited to beam measurement. The measurement report may also be referred to as measurement feedback, the measurement report may include but is not limited to a beam measurement report, and the measurement feedback includes but is not limited to beam measurement feedback. The measurement report configuration may also be referred to as a measurement feedback configuration, the measurement report configuration may include but is not limited to a beam measurement report configuration, and the measurement feedback configuration includes but is not limited to a beam measurement feedback configuration.

Optionally, in some embodiments, the first information is the measurement report, or the first information is the measurement report configuration.

When the first information is the measurement report, the first device may be understood as a terminal, and the second device may be understood as a network side device. When the first information is the measurement report configuration, the first device may be understood as a network side device, and the second device may be understood as a terminal. The measurement report may include a beam measurement report, and the measurement report configuration information may include beam measurement report configuration information.

Optionally, in some embodiments, when the first information is the measurement report configuration, the association information includes at least one of the measurement feedback function information, the first quantity, and the second quantity, where the second quantity may be determined based on the first quantity. In other words, the network side device associates the measurement report configuration with at least one of the measurement feedback function information and indication information of the first quantity (such as first indication information), where the association may be understood as that the measurement report configuration includes at least one of the measurement feedback function information and the indication information of the first quantity, or may be understood as that the measurement report configuration has an association relationship with at least one of the measurement feedback function information and the first quantity. In this embodiment of this application, the measurement report configuration is associated with at least one of the measurement feedback function information and the indication information of the first quantity, to limit the measurement report reported by the terminal. In this way, the network side device can accurately learn of the measurement report type corresponding to the measurement report reported by the terminal and/or the quantity of target information.

Optionally, in some embodiments, when the first information is the measurement report, the association information includes at least one of the measurement feedback function information and the second quantity. In other words, the terminal associates the measurement report with at least one of the measurement feedback function information and indication information of the second quantity (such as third indication information), where the association may be understood as that the measurement report includes at least one of the measurement feedback function information and the indication information of the second quantity, or may be understood as that the measurement report has an association relationship with at least one of the measurement feedback function information and the indication information of the second quantity. In this embodiment of this application, the measurement report is associated with at least one of the measurement feedback function information and the indication information of the second quantity, that is, the terminal indicates, to the network side device, the measurement report type corresponding to the measurement report and/or the quantity of target information. In this way, the network side device can accurately learn of the measurement report type corresponding to the measurement report reported by the terminal and/or the quantity of target information.

It should be noted that the quantity of target information may be understood as a quantity of information corresponding to the reference signal, or may be understood as a total quantity of information corresponding to the reference signal and channel quality information, where the information corresponding to the reference signal and the channel quality information are associated with each other. For example, the network side device configures the measurement report including four pieces of target information for the terminal. The measurement report that is fed back actually includes four RSRPs and indexes of reference signals corresponding to the four RSRPs. In this case, the second quantity is 4, and may be indicated as a quantity of RSRPs, a quantity of indexes of reference signals corresponding to RSRPs, or a total quantity of RSRPs and indexes of reference signals corresponding to the RSRPs.

Optionally, the information corresponding to the reference signal may be referred to as beam information. In some embodiments, the information corresponding to the reference signal includes at least one of the following: information used to determine a spatial domain filter identifier of a sending direction, information used to determine a spatial domain filter identifier of a receiving direction, information used to determine a spatial domain filter identifier, angle-related information of the sending direction, angle-related information of the receiving direction, angle-related information, spatial domain filter expectation-related information of the sending direction, and spatial domain filter expectation-related information of the receiving direction.

In other words, the beam information includes at least one of the following: beam identifier-related information of a transmit beam, beam identifier-related information of a receive beam, beam identifier-related information of a beam pair, angle-related information of the transmit beam, angle-related information of the receive beam, angle-related information, beam gain-related information, beam width-related information, transmit beam expectation-related information, and receive beam expectation-related information.

The beam identifier-related information indicates information related to identification of the beam, and includes but is not limited to at least one of the following: a beam ID, a reference signal set ID corresponding to a beam, a reference signal resource ID corresponding to a beam, a uniquely identified random ID, an additional coding value processed by an AI network, angle-related information, and the like. For example, in some embodiments, the beam identifier-related information may include a channel state information reference signal resource indicator (CRI), a synchronization signal block resource indicator (SSBRI), and the like.

Optionally, the angle-related information indicates angle-related information corresponding to the beam, and the angle-related information specifically indicates information related to an angle or an identity, such as an angle, a radian, an index coding value, an ID value, and an additional coding value processed by an AI network.

Optionally, in some embodiments, the channel quality information includes at least one of the following: a layer 1 signal to interference plus noise ratio, a layer 1 reference signal received power, layer 1 reference signal received quality, a layer 3 signal to interference plus noise ratio (L3-SINR), a layer 3 reference signal received power (L3-RSRP), and layer 3 reference signal received quality (L3-RSRQ).

In this embodiment of this application, the first device sends the first information to the second device, where the first information is used to determine the association information of the measurement report, and the association information includes at least one of the following: the measurement feedback function information; the first quantity; and the second quantity. In this way, the measurement report type corresponding to the measurement report and/or the quantity of target information may be determined, to ensure that the network side device can correctly understand the measurement report, and improve communication reliability.

Optionally, in some embodiments, the method further includes:

The first device receives second information from the second device, where
in a case that the first information is the measurement report configuration, the second information is the measurement report; and in a case that the first information is the measurement report, the second information is the measurement report configuration.

Usually, the network side device first sends the measurement report configuration to the terminal. Then, after the terminal performs corresponding measurement, the terminal sends the measurement report to the network side device.

Optionally, the measurement report configuration is associated with at least one of the measurement feedback function information and first indication information, and the first indication information is used to determine the first quantity.

In this embodiment of this application, the first indication information may indicate the first quantity, or the first quantity may be determined based on both the first indication information and second indication information that is associated with the measurement report configuration, and the second indication information is used to determine the quantity of the target information associated with the measurement report. In some embodiments, the second indication information may be specifically in a parameter maxNrofRS-IndexesToReport, that is, the second indication information may be referred to as maxNrofRS-IndexesToReport indication information. Optionally, the second indication information associated with the measurement report configuration may be understood as that the measurement report configuration includes the second indication information or the measurement report configuration has an association relationship with the second indication information.

Optionally, the measurement report is associated with at least one of the following: the measurement feedback function information and third indication information, and the third indication information is used to determine the second quantity.

In this embodiment of this application, In a case that both the measurement report and the measurement report configuration are associated with the measurement report type and/or the quantity of target information, consistency of understanding of the measurement report between the terminal and the network side device can be further improved. In a case that the measurement report is associated with one of the measurement report type and the quantity of target information, and the measurement report configuration is associated with the other one of the measurement report type and the quantity of target information, so that the network side device can accurately understand the measurement report type of the measurement report and the quantity of target information, to improve the consistency of understanding of the measurement report between the terminal and the network side device.

Optionally, the third indication information may indicate the second quantity or a third quantity, and the third quantity is used to determine the second quantity with the first quantity through calculation. For example, in some embodiments, the third quantity indicates a difference between the first quantity and the second quantity, and the second quantity is less than or equal to the first quantity. In some embodiments, the third quantity may alternatively be indicated as a coefficient or a multiple value. For example, the second quantity may be obtained by multiplying the first quantity by the third quantity. Assuming that the first quantity associated with the measurement report configuration is 16 and the third quantity associated with the measurement report is 0.5, it indicates that the measurement report is associated with information corresponding to eight reference signals.

It should be noted that in this embodiment of this application, after receiving the second information from the second device, the first device may determine at least one of the following of the measurement report according to the second information: the measurement feedback function information, the first quantity, and the second quantity.

Optionally, in some embodiments, in a case that the measurement report configuration is not associated with the measurement feedback function information, the measurement report may be the normal measurement report by default.

Optionally, in some embodiments, the measurement feedback function information is associated with a report type parameter of the measurement report configuration, or the measurement feedback function information is associated with a first parameter in a report type parameter of the measurement report configuration.

In this embodiment of this application, the report type parameter may be a report quantity. For example, a new report quantity may be designed. For example, cri-RSRP-normal is used to represent the normal measurement report, cri-RSRP-prediction is used to represent the prediction measurement report, and cri-RSRP-enhanced is used to represent the enhanced measurement report.

It should be noted that in this embodiment of this application, that the measurement feedback function information is associated with the report type parameter of the measurement report configuration may be understood as that the report type parameter includes the measurement feedback function information or the report type parameter has an association relationship with the measurement feedback function information. That the measurement feedback function information is associated with the first parameter in the report type parameter of the measurement report configuration may be understood as that the first parameter includes the measurement feedback function information or the first parameter has an association relationship with the measurement feedback function information.

Optionally, that the measurement feedback function information is associated with the first parameter in the report type parameter of the measurement report configuration may be understood as that the measurement feedback function information is associated with a next-level parameter of the report type parameter. In some embodiments, the first parameter is associated with a channel state information reference signal or a synchronization signal block. In other words, the first parameter may be cri-RSRP or ssb-Index-RSRP.

Optionally, in a case that the measurement feedback function information is not associated with cri-RSRP or ssb-Index-RSRP, the measurement report may be the normal measurement report by default.

Optionally, in some embodiments, the measurement report configuration meets any one of the following:
in a case that the measurement report configuration is associated with the first indication information, second indication information associated with the measurement report configuration is invalid;
the measurement report configuration is associated only with the first indication information or second indication information; and
in a case that the measurement report configuration is associated with the first indication information and second indication information, the first quantity is determined based on both the first indication information and the second indication information, where
the second indication information is used to determine a quantity of the target information associated with the measurement report.

In this embodiment of this application, the second indication information may be specifically in a parameter maxNrofRS-IndexesToReport.

Optionally, in some embodiments, the first quantity meets at least one of the following:
in a case that the measurement report configuration is not associated with the first indication information, the first quantity is a first default value; and
in a case that the measurement report configuration is not associated with the first indication information and the first quantity is determined based on the first indication information and second indication information, the first quantity is a second default value, where the second indication information is used to determine a quantity of the target information associated with the measurement report.

In this embodiment of this application, the first default value is different from the second default value, the first default value may be 1, and the second default value may be 0.

Optionally, in some embodiments, the measurement report meets at least one of the following:
in a case that the measurement report is associated with first bit information, the measurement report type corresponding to the measurement report is the prediction measurement report or the enhanced measurement report, and different values of the first bit information indicate the prediction measurement report and the enhanced measurement report; and in a case that the measurement report does not include the first bit information, the measurement report is associated with the normal measurement report;
in a case that the measurement report is associated with second bit information, the measurement report type corresponding to the measurement report is the normal measurement report, the prediction measurement report, or the enhanced measurement report, and different values of the second bit information indicate that measurement report types are the normal measurement report, the prediction measurement report, and the enhanced measurement report;
in a case that the measurement report is associated with third bit information, the measurement report type corresponding to the measurement report is measurement feedback or the prediction measurement report, and different values of the third bit information indicate the measurement feedback and the prediction measurement report; and
in a case that the measurement report is associated with fourth bit information, the measurement report type corresponding to the measurement report is the normal measurement report or the enhanced measurement report, and different values of the fourth bit information indicate the normal measurement report and the enhanced measurement report.

In this embodiment of this application, the first bit information, the third bit information, and the fourth bit information may be understood as one bit, that is, one bit is used to indicate the measurement report type. For example, in some embodiments, an indication manner may include the following cases:

One bit is used to indicate the enhanced measurement report or the normal measurement report.

One bit is used to indicate the prediction measurement report or the normal measurement report.

One bit is used to indicate the enhanced measurement report or the prediction measurement report, and default indicates the normal measurement report in this case.

The second bit information may be two bits, that is, two bits are used to indicate the measurement report type. For example, 00 indicates the normal measurement report, 01 indicates the prediction measurement report, and 10 indicates the enhanced measurement report.

It should be noted that, that the measurement report is associated with the bit information (such as the first bit information, the second bit information, the third bit information, and the fourth bit information) may be understood as that the measurement report includes the corresponding bit information, or may be understood as that the measurement report has an association relationship with the corresponding bit information.

Optionally, in some embodiments, the measurement report type corresponding to the measurement report is one of at least two measurement report types associated with the measurement report configuration.

For example, the measurement report configuration is associated with the prediction measurement report and the normal measurement report, so that one measurement report type in the prediction measurement report and the normal measurement report can be fed back by using one bit. In other words, the measurement report type indicated by the first bit information, the second bit information, the third bit information, and the fourth bit information is determined according to the configured measurement report type.

Optionally, a bit overhead for at least one of the first bit information, the second bit information, the third bit information, and the fourth bit information is determined based on a quantity of measurement report types associated with the measurement report configuration.

Optionally, in some embodiments, a bit size of the third indication information is associated with the first quantity.

Optionally, the measurement report meets at least one of the following:
in a case that the measurement report type is the prediction measurement report, the measurement report is associated with at least a part of predicted results obtained by performing prediction based on a measurement result; and
in a case that the measurement report type is the enhanced measurement report, the measurement report is associated with all measurement results or a measurement result that meets a first condition.

In this embodiment of this application, that the measurement report is associated with at least a part of predicted results obtained by performing prediction based on a measurement result may be understood as that the measurement report includes at least the part of the predicted results or the measurement report has an association relationship with at least the part of the predicted results.

Optionally, that the measurement report is associated with all measurement results or a measurement result that meets a first condition may be understood as that the measurement report includes all the measurement results or the measurement result that meets the first condition or the measurement report has an association relationship with all the measurement results or the measurement result that meets the first condition.

Optionally, the measurement result that meets the first condition includes at least one of the following:
a first measurement result greater than a first threshold;
a second measurement equal to the first threshold;
a third measurement results less than a second threshold; and
a fourth measurement equal to the second threshold, where
the first threshold is less than the second threshold.

Optionally, in a case that the measurement report type is prediction feedback, the method further includes:
in a case that the first information is the measurement report, receiving, by the first device from the second device, information corresponding to a reference signal available to the second device; and
in a case that the first information is the measurement report configuration, sending, by the first device to the second device, information corresponding to a reference signal available to the first device.

In this embodiment of this application, the information corresponding to the reference signal may be understood as beam information, and the available beam information may be understood as beam information of an available transmit beam and/or beam information of an available receive beam. The information corresponding to the available reference signal may be used for beam prediction. The enhanced beam measurement may be used for AI model training.

Optionally, in some embodiments, the target information meets at least one of the following:
in a case that feedback information associated with the measurement report includes the information corresponding to the reference signal and the channel quality information, the target information includes at least one of the information corresponding to the reference signal and the channel quality information; and
in a case that feedback information associated with the measurement report includes the information corresponding to the reference signal, the target information includes at least partial information in the information corresponding to the reference signal.

Optionally, in some embodiments, the at least partial information includes at least one of the following: information used to determine a spatial domain filter identifier of a sending direction, information used to determine a spatial domain filter identifier of a receiving direction, information used to determine a spatial domain filter identifier, angle-related information of the sending direction, angle-related information of the receiving direction, angle-related information, spatial domain filter expectation-related information of the sending direction, and spatial domain filter expectation-related information of the receiving direction.

As shown in FIG. 7, an embodiment of this application further provides a measurement feedback processing method. As shown in FIG. 7, the measurement feedback processing method includes the following steps:

Step 701: A second device receives first information from a first device.

Step 702: The second device determines association information of a measurement report according to the first information, where the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

Optionally, the first information is the measurement report, or the first information is the measurement report configuration.

Optionally, the method further includes:

The second device sends second information to the first device, where
in a case that the first information is the measurement report configuration, the second information is the measurement report; and in a case that the first information is the measurement report, the second information is the measurement report configuration.

Optionally, the measurement report configuration is associated with at least one of the measurement feedback function information and first indication information, and the first indication information is used to determine the first quantity.

Optionally, the measurement feedback function information is associated with a report type parameter of the measurement report configuration, or the measurement feedback function information is associated with a first parameter in a report type parameter of the measurement report configuration.

Optionally, the first parameter is associated with a channel state information reference signal or a synchronization signal block.

Optionally, the measurement report configuration meets any one of the following:
in a case that the measurement report configuration is associated with the first indication information, second indication information associated with the measurement report configuration is invalid;
the measurement report configuration is associated only with the first indication information or second indication information; and
in a case that the measurement report configuration is associated with the first indication information and second indication information, the first quantity is determined based on both the first indication information and the second indication information, where
the second indication information is used to determine a quantity of the target information associated with the measurement report.

Optionally, the first quantity meets at least one of the following:
in a case that the measurement report configuration is not associated with the first indication information, the first quantity is a first default value; and
in a case that the measurement report configuration is not associated with the first indication information and the first quantity is determined based on the first indication information and second indication information, the first quantity is a second default value, where
the second indication information is used to determine a quantity of the target information associated with the measurement report.

Optionally, the measurement report is associated with at least one of the following: the measurement feedback function information and third indication information, and the third indication information is used to determine the second quantity.

Optionally, the measurement report meets at least one of the following:
in a case that the measurement report is associated with first bit information, the measurement report type corresponding to the measurement report is the prediction measurement report or the enhanced measurement report, and different values of the first bit information indicate the prediction measurement report and the enhanced measurement report; and in a case that the measurement report does not include the first bit information, the measurement report is associated with the normal measurement report;
in a case that the measurement report is associated with second bit information, the measurement report type corresponding to the measurement report is the normal measurement report, the prediction measurement report, or the enhanced measurement report, and different values of the second bit information indicate that measurement report types are the normal measurement report, the prediction measurement report, and the enhanced measurement report;
in a case that the measurement report is associated with third bit information, the measurement report type corresponding to the measurement report is measurement feedback or the prediction measurement report, and different values of the third bit information indicate the measurement feedback and the prediction measurement report; and
in a case that the measurement report is associated with fourth bit information, the measurement report type corresponding to the measurement report is the normal measurement report or the enhanced measurement report, and different values of the fourth bit information indicate the normal measurement report and the enhanced measurement report.

Optionally, the measurement report type corresponding to the measurement report is one of at least two measurement report types associated with the measurement report configuration.

Optionally, a bit size of the third indication information is associated with the first quantity.

Optionally, the measurement report meets at least one of the following:
in a case that the measurement report type is the prediction measurement report, the measurement report is associated with at least a part of predicted results obtained by performing prediction based on a measurement result; and
in a case that the measurement report type is the enhanced measurement report, the measurement report is associated with all measurement results or a measurement result that meets a first condition.

Optionally, the measurement result that meets the first condition includes at least one of the following:
a first measurement result greater than a first threshold;
a second measurement equal to the first threshold;
a third measurement results less than a second threshold; and
a fourth measurement equal to the second threshold, where
the first threshold is less than the second threshold.

Optionally, in a case that the measurement report type is prediction feedback, the method further includes:
In a case that the first information is the measurement report, the second device sends, to the first device, information about a beam available to the second device; and
in a case that the first information is the measurement report configuration, the second device receives, from the first device, information about a beam available to the first device.

Optionally, the target information meets at least one of the following:
in a case that the measurement report configuration is not associated with the first indication information, the first quantity is a first default value; and
in a case that the measurement report configuration is not associated with the first indication information and the first quantity is determined based on the first indication information and second indication information, the first quantity is a second default value, where
the second indication information is used to determine a quantity of the target information associated with the measurement report.

Optionally, the at least partial information includes at least one of the following: information used to determine a spatial domain filter identifier of a sending direction, information used to determine a spatial domain filter identifier of a receiving direction, information used to determine a spatial domain filter identifier, angle-related information of the sending direction, angle-related information of the receiving direction, angle-related information, spatial domain filter expectation-related information of the sending direction, and spatial domain filter expectation-related information of the receiving direction.

The measurement feedback processing method provided in this embodiment of this application may be performed by a measurement feedback processing apparatus. In the embodiments of this application, the measurement feedback processing apparatus provided in the embodiments of this application is described by using an example in which the measurement feedback processing apparatus performs the measurement feedback processing method.

Refer to FIG. 8. An embodiment of this application further provides a measurement feedback processing apparatus. As shown in FIG. 8, the measurement feedback processing apparatus 800 includes:
a first sending module 801, configured to send first information to a second device, where the first information is used to determine association information of a measurement report, and the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

Optionally, the first information is the measurement report, or the first information is the measurement report configuration.

Optionally, the measurement feedback processing apparatus 800 further includes:
a first receiving module, configured to receive second information from the second device, where
in a case that the first information is the measurement report configuration, the second information is the measurement report; and in a case that the first information is the measurement report, the second information is the measurement report configuration.

Optionally, the measurement report configuration is associated with at least one of the measurement feedback function information and first indication information, and the first indication information is used to determine the first quantity.

Optionally, the measurement feedback function information is associated with a report type parameter of the measurement report configuration, or the measurement feedback function information is associated with a first parameter in a report type parameter of the measurement report configuration.

Optionally, the first parameter is associated with a channel state information reference signal or a synchronization signal block.

Optionally, the measurement report configuration meets any one of the following:
in a case that the measurement report configuration is associated with the first indication information, second indication information associated with the measurement report configuration is invalid;
the measurement report configuration is associated only with the first indication information or second indication information; and
in a case that the measurement report configuration is associated with the first indication information and second indication information, the first quantity is determined based on both the first indication information and the second indication information, where
the second indication information is used to determine a quantity of the target information associated with the measurement report.

Optionally, the first quantity meets at least one of the following:
in a case that the measurement report configuration is not associated with the first indication information, the first quantity is a first default value; and
in a case that the measurement report configuration is not associated with the first indication information and the first quantity is determined based on the first indication information and second indication information, the first quantity is a second default value, where
the second indication information is used to determine a quantity of the target information associated with the measurement report.

Optionally, the measurement report is associated with at least one of the following: the measurement feedback function information and third indication information, and the third indication information is used to determine the second quantity.

Optionally, the measurement report meets at least one of the following:
in a case that the measurement report is associated with first bit information, the measurement report type corresponding to the measurement report is the prediction measurement report or the enhanced measurement report, and different values of the first bit information indicate the prediction measurement report and the enhanced measurement report; and in a case that the measurement report does not include the first bit information, the measurement report is associated with the normal measurement report;
in a case that the measurement report is associated with second bit information, the measurement report type corresponding to the measurement report is the normal measurement report, the prediction measurement report, or the enhanced measurement report, and different values of the second bit information indicate that measurement report types are the normal measurement report, the prediction measurement report, and the enhanced measurement report;
in a case that the measurement report is associated with third bit information, the measurement report type corresponding to the measurement report is measurement feedback or the prediction measurement report, and different values of the third bit information indicate the measurement feedback and the prediction measurement report; and
in a case that the measurement report is associated with fourth bit information, the measurement report type corresponding to the measurement report is the normal measurement report or the enhanced measurement report, and different values of the fourth bit information indicate the normal measurement report and the enhanced measurement report.

Optionally, the measurement report type corresponding to the measurement report is one of at least two measurement report types associated with the measurement report configuration.

Optionally, a bit size of the third indication information is associated with the first quantity.

Optionally, the measurement report meets at least one of the following:
in a case that the measurement report type is the prediction measurement report, the measurement report is associated with at least a part of predicted results obtained by performing prediction based on a measurement result; and
in a case that the measurement report type is the enhanced measurement report, the measurement report is associated with all measurement results or a measurement result that meets a first condition.

Optionally, the measurement result that meets the first condition includes at least one of the following:
a first measurement result greater than a first threshold;
a second measurement equal to the first threshold;
a third measurement results less than a second threshold; and
a fourth measurement equal to the second threshold, where
the first threshold is less than the second threshold.

Optionally, in a case that a feedback type is prediction feedback, the measurement feedback processing apparatus 800 further includes the first receiving module.

In a case that the first information is the measurement report, the first receiving module is configured to receive, from the second device, information corresponding to a reference signal available to the second device.

In a case that the first information is the measurement report configuration, the first sending module is further configured to send, to the second device, information corresponding to a reference signal available to the first device.

Optionally, the target information meets at least one of the following:
in a case that feedback information associated with the measurement report includes the information corresponding to the reference signal and the channel quality information, the target information includes at least one of the information corresponding to the reference signal and the channel quality information; and
in a case that feedback information associated with the measurement report includes the information corresponding to the reference signal, the target information includes at least partial information in the information corresponding to the reference signal.

Optionally, the at least partial information includes at least one of the following: information used to determine a spatial domain filter identifier of a sending direction, information used to determine a spatial domain filter identifier of a receiving direction, information used to determine a spatial domain filter identifier, angle-related information of the sending direction, angle-related information of the receiving direction, angle-related information, spatial domain filter expectation-related information of the sending direction, and spatial domain filter expectation-related information of the receiving direction.

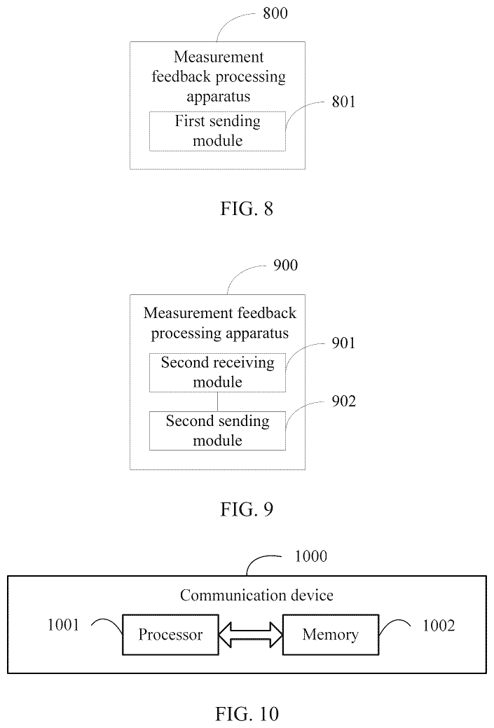

Refer to FIG. 9. An embodiment of this application further provides a measurement feedback processing apparatus. As shown in FIG. 9, the measurement feedback processing apparatus 900 includes:
a second receiving module 901, configured to receive first information from a first device; and
a second sending module 902, configured to determine association information of a measurement report according to the first information, where the association information includes at least one of the following:
measurement feedback function information;
a first quantity; and
a second quantity, where
the measurement feedback function information indicates any one of the following feedback types: measurement feedback for first beam measurement, prediction feedback based on first beam measurement, and enhanced measurement feedback for first beam measurement, the first quantity is determined based on the measurement report configuration, the first quantity indicates at least one of the following: a quantity of target information in feedback information associated with the measurement report, a maximum quantity of target information in feedback information associated with the measurement report, and a minimum quantity of target information in feedback information associated with the measurement report, the second quantity is determined based on the measurement report, the second quantity indicates a quantity of target information in feedback information associated with the measurement report, and the feedback information includes at least one of beam information and channel quality information.

Optionally, the first information is the measurement report, or the first information is the measurement report configuration.

Optionally, the second sending module 902 is further configured to send second information to the first device, where
in a case that the first information is the measurement report configuration, the second information is the measurement report; and in a case that the first information is the measurement report, the second information is the measurement report configuration.

Optionally, the measurement report configuration is associated with at least one of the measurement feedback function information and first indication information, and the first indication information is used to determine the first quantity.

Optionally, the measurement report configuration is associated with at least one of the measurement feedback function information and first indication information, and the first indication information is used to determine the first quantity.

Optionally, the measurement feedback function information is associated with a report type parameter of the measurement report configuration, or the measurement feedback function information is associated with a first parameter in a report type parameter of the measurement report configuration.

Optionally, the first parameter is associated with a channel state information reference signal or a synchronization signal block.

Optionally, the measurement report configuration meets any one of the following:
in a case that the measurement report configuration is associated with the first indication information, second indication information associated with the measurement report configuration is invalid;
the measurement report configuration is associated only with the first indication information or second indication information; and
in a case that the measurement report configuration is associated with the first indication information and second indication information, the first quantity is determined based on both the first indication information and the second indication information, where
the second indication information is used to determine a quantity of the target information associated with the measurement report.

Optionally, the first quantity meets at least one of the following:
in a case that the measurement report configuration is not associated with the first indication information, the first quantity is a first default value; and
in a case that the measurement report configuration is not associated with the first indication information and the first quantity is determined based on the first indication information and second indication information, the first quantity is a second default value, where
the second indication information is used to determine a quantity of the target information associated with the measurement report.

Optionally, the measurement report is associated with at least one of the following: the measurement feedback function information and third indication information, and the third indication information is used to determine the second quantity.

Optionally, the measurement report meets at least one of the following:
in a case that the measurement report is associated with first bit information, the measurement report type corresponding to the measurement report is the prediction measurement report or the enhanced measurement report, and different values of the first bit information indicate the prediction measurement report and the enhanced measurement report; and in a case that the measurement report does not include the first bit information, the measurement report is associated with the normal measurement report;
in a case that the measurement report is associated with second bit information, the measurement report type corresponding to the measurement report is the normal measurement report, the prediction measurement report, or the enhanced measurement report, and different values of the second bit information indicate that measurement report types are the normal measurement report, the prediction measurement report, and the enhanced measurement report;
in a case that the measurement report is associated with third bit information, the measurement report type corresponding to the measurement report is measurement feedback or the prediction measurement report, and different values of the third bit information indicate the measurement feedback and the prediction measurement report; and
in a case that the measurement report is associated with fourth bit information, the measurement report type corresponding to the measurement report is the normal measurement report or the enhanced measurement report, and different values of the fourth bit information indicate the normal measurement report and the enhanced measurement report.

Optionally, the measurement report type corresponding to the measurement report is one of at least two measurement report types associated with the measurement report configuration.

Optionally, a bit size of the third indication information is associated with the first quantity.

Optionally, the measurement report meets at least one of the following:
in a case that the measurement report type is the prediction measurement report, the measurement report is associated with at least a part of predicted results obtained by performing prediction based on a measurement result; and
in a case that the measurement report type is the enhanced measurement report, the measurement report is associated with all measurement results or a measurement result that meets a first condition.

Optionally, the measurement result that meets the first condition includes at least one of the following:
a first measurement result greater than a first threshold;
a second measurement equal to the first threshold;
a third measurement results less than a second threshold; and
a fourth measurement equal to the second threshold, where
the first threshold is less than the second threshold.

Optionally, in a case that the feedback type is the prediction feedback and the first information is the measurement report, the second sending module 902 is further configured to send, to the first device, information corresponding to a reference signal available to the second device; and
in a case that the feedback type is the prediction feedback and the first information is the measurement report configuration, the second receiving module 901 is further configured to receive, from the first device, information corresponding to a reference signal available to the first device.

Optionally, the target information meets at least one of the following:
in a case that feedback information associated with the measurement report includes the information corresponding to the reference signal and the channel quality information, the target information includes at least one of the information corresponding to the reference signal and the channel quality information; and
in a case that feedback information associated with the measurement report includes the information corresponding to the reference signal, the target information includes at least partial information in the information corresponding to the reference signal.

Optionally, the at least partial information includes at least one of the following: information used to determine a spatial domain filter identifier of a sending direction, information used to determine a spatial domain filter identifier of a receiving direction, information used to determine a spatial domain filter identifier, angle-related information of the sending direction, angle-related information of the receiving direction, angle-related information, spatial domain filter expectation-related information of the sending direction, and spatial domain filter expectation-related information of the receiving direction.

The measurement feedback processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The measurement feedback processing apparatus provided in this embodiment of this application can implement the processes implemented in the method embodiments in FIG. 6 and FIG. 7, and achieve a same technical effect. To avoid repetition, details are not described herein again.

Optionally, as shown in FIG. 10, an embodiment of this application further provides a communication device 1000, including a processor 1001 and a memory 1002. The memory 1002 stores a program or an instruction that is executable on the processor 1001. The program or the instruction is executed by the processor 1001 to implement the processes of the foregoing measurement feedback processing method embodiments, and a same technical effect can be achieved. To avoid repetition, details are not described herein again.

An embodiment of this application further provides a terminal, including a processor and a communications interface.

When the terminal is a first device, the communication interface is configured to send first information to a second device, where the first information is used to determine association information of a measurement report, and the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

Alternatively, when the terminal is a second device, the communication interface is configured to receive first information from a first device; and determine association information of a measurement report according to the first information, where the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

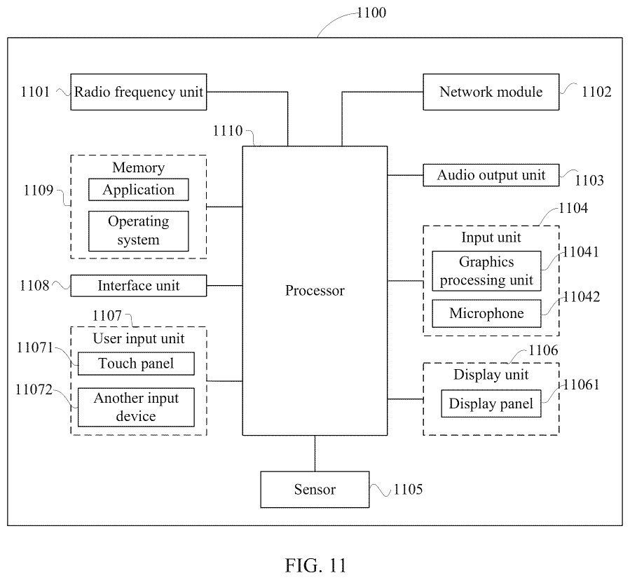

The terminal embodiment corresponds to the terminal side method embodiment, each implementation process and implementation of the method embodiment can be applied to the terminal embodiment, and a same technical effect can be achieved. Specifically, FIG. 11 is a schematic diagram of a hardware structure of a terminal according to an embodiment of this application.

The terminal 1100 includes but is not limited to at least a part of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the terminal 1100 may further include a power supply (such as a battery) that supplies power to each component. The power supply may be logically connected to the processor 1110 by using a power supply management system, to implement functions such as charging and discharging management, and power consumption management by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that, in this embodiment of this application, the input unit 1104 may include a graphics processing unit (GPU) 11041 and a microphone 11042, and the graphics processing unit 11041 processes image data of a still picture or a video obtained by an image capture apparatus (such as a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Generally, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 1109 in this embodiment of this application includes but is not limited to these memories and any memory of another proper type.

The processor 1110 may include one or more processing units. Optionally, an application processor and a modem processor are integrated into the processor 1110. The application processor mainly processes an operating system, a user interface, an application, and the like. The modem processor mainly processes a wireless communication signal, for example, a baseband processor. It may be understood that, alternatively, the modem processor may not be integrated into the processor 1110.

When the terminal is a first device, the radio frequency unit 1101 is configured to send first information to a second device, where the first information is used to determine association information of a measurement report, and the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

Alternatively, when the terminal is a second device, the radio frequency unit 1101 is configured to receive first information from a first device; and determine association information of a measurement report according to the first information, where the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

An embodiment of this application further provides a network side device, and includes a processor and a communication interface.

When the network side device is a first device, the communication interface is configured to send first information to a second device, where the first information is used to determine association information of a measurement report, and the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

Alternatively, when the network side device is a second device, the communication interface is configured to receive first information from a first device; and determine association information of a measurement report according to the first information, where the association information includes at least one of the following:
measurement feedback function information indicating a measurement report type;
a first quantity; and
a second quantity, where
the measurement report type includes any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information includes at least one of information corresponding to a reference signal and channel quality information.

The network side device embodiment corresponds to the method embodiment of the network side device, each implementation process and implementation of the method embodiment can be applied to the network side device embodiment, and a same technical effect can be achieved.

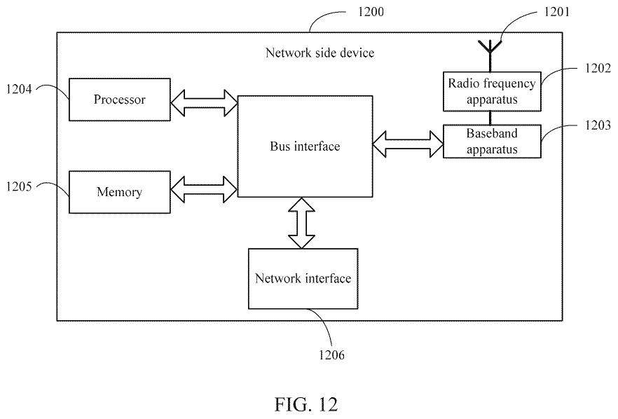

Specifically, an embodiment of this application further provides a network side device. As shown in FIG. 12, the network side device 1200 includes an antenna 1201, a radio frequency apparatus 1202, a baseband apparatus 1203, a processor 1204, and a memory 1205. The antenna 1201 is connected to the radio frequency apparatus 1202. In an uplink direction, the radio frequency apparatus 1202 receives information through the antenna 1201, and sends the received information to the baseband apparatus 1203 for processing. In a downlink direction, the baseband apparatus 1203 processes information that needs to be sent, and sends processed information to the radio frequency apparatus 1202. The radio frequency apparatus 1202 processes the received information, and sends processed information through the antenna 1201.

In the foregoing embodiment, the method performed by the network side device may be implemented in the baseband apparatus 1203. The baseband apparatus 1203 includes a baseband processor.

For example, the baseband apparatus 1203 may include at least one baseband board. A plurality of chips are disposed on the baseband board. As shown in FIG. 12, one chip is, for example, a baseband processor, and is connected to the memory 1205 by using a bus interface, to invoke a program in the memory 1205 to perform the operations of the network device shown in the foregoing method embodiment.

The network side device may further include a network interface 1206, and the interface is, for example, a common public radio interface (CPRI).

Specifically, the network side device 1200 in this embodiment of this application further includes an instruction or a program that is stored in the memory 1205 and that is executable on the processor 1204. The processor 1204 invokes the instruction or the program in the memory 1205 to execute the method executed by the modules shown in FIG. 9, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing measurement feedback processing method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random-access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing measurement feedback processing method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the program/program product is executed by at least one processor to implement the processes of the foregoing measurement feedback processing method embodiment, and a same technical effect can be achieved. To avoid repetition, details are not described herein again.

An embodiment of this application further provides a communication system, including a first device and a second device. The first device is configured to perform the processes of the method embodiments in FIG. 6 and the first device side, and the second device is configured to perform the processes of the method embodiments in FIG. 7 and the second device side, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a desirable implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A measurement feedback processing method, comprising:
sending, by a first device, first information to a second device, wherein the first information is used to determine association information of a measurement report, and the association information comprises at least one of the following:
measurement feedback function information indicating a measurement report type;
a first quantity; and
a second quantity, wherein
the measurement report type comprises any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information comprises at least one of information corresponding to a reference signal and channel quality information.

2. The method according to claim 1, wherein the first information is the measurement report, or the first information is the measurement report configuration.

3. The method according to claim 2, wherein the method further comprises:
receiving, by the first device, second information from the second device, wherein
in a case that the first information is the measurement report configuration, the second information is the measurement report; and in a case that the first information is the measurement report, the second information is the measurement report configuration.

4. The method according to claim 1, wherein in a case that the measurement report type is prediction feedback, the method further comprises:
in a case that the first information is the measurement report, receiving, by the first device from the second device, information corresponding to a reference signal available to the second device; and
in a case that the first information is the measurement report configuration, sending, by the first device to the second device, information corresponding to a reference signal available to the first device.

5. The method according to claim 4, wherein the target information meets at least one of the following:
in a case that feedback information associated with the measurement report comprises the information corresponding to the reference signal and the channel quality information, the target information comprises at least one of the information corresponding to the reference signal and the channel quality information; and
in a case that feedback information associated with the measurement report comprises the information corresponding to the reference signal, the target information comprises at least partial information in the information corresponding to the reference signal.

6. The method according to claim 5, wherein the at least partial information comprises at least one of the following: information used to determine a spatial domain filter identifier of a sending direction, information used to determine a spatial domain filter identifier of a receiving direction, information used to determine a spatial domain filter identifier, angle-related information of the sending direction, angle-related information of the receiving direction, angle-related information, spatial domain filter expectation-related information of the sending direction, and spatial domain filter expectation-related information of the receiving direction.

7. A measurement feedback processing method, comprising:
receiving, by a second device, first information from a first device; and
determining, by the second device, association information of a measurement report according to the first information, wherein the association information comprises at least one of the following:
measurement feedback function information indicating a measurement report type;
a first quantity; and
a second quantity, wherein
the measurement report type comprises any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information comprises at least one of information corresponding to a reference signal and channel quality information.

8. The method according to claim 7, wherein the measurement report configuration is associated with at least one of the measurement feedback function information and first indication information, and the first indication information is used to determine the first quantity.

9. The method according to claim 8, wherein the measurement feedback function information is associated with a report type parameter of the measurement report configuration, or the measurement feedback function information is associated with a first parameter in a report type parameter of the measurement report configuration.

10. The method according to claim 9, wherein the first parameter is associated with a channel state information reference signal or a synchronization signal block.

11. The method according to claim 8, wherein the measurement report configuration meets any one of the following:
in a case that the measurement report configuration is associated with the first indication information, second indication information associated with the measurement report configuration is invalid;
the measurement report configuration is associated only with the first indication information or second indication information; and
in a case that the measurement report configuration is associated with the first indication information and second indication information, the first quantity is determined based on both the first indication information and the second indication information, wherein
the second indication information is used to determine a quantity of the target information associated with the measurement report.

12. The method according to claim 8, wherein the first quantity meets at least one of the following:
in a case that the measurement report configuration is not associated with the first indication information, the first quantity is a first default value; and
in a case that the measurement report configuration is not associated with the first indication information and the first quantity is determined based on the first indication information and second indication information, the first quantity is a second default value, wherein
the second indication information is used to determine a quantity of the target information associated with the measurement report.

13. The method according to claim 7, wherein the measurement report is associated with at least one of the following: the measurement feedback function information and third indication information, and the third indication information is used to determine the second quantity.

14. The method according to claim 13, wherein the measurement report meets at least one of the following:
in a case that the measurement report is associated with first bit information, the measurement report type corresponding to the measurement report is the prediction measurement report or the enhanced measurement report, and different values of the first bit information indicate the prediction measurement report and the enhanced measurement report;
and in a case that the measurement report does not comprise the first bit information, the measurement report is associated with the normal measurement report;
in a case that the measurement report is associated with second bit information, the measurement report type corresponding to the measurement report is the normal measurement report, the prediction measurement report, or the enhanced measurement report, and different values of the second bit information indicate that measurement report types are the normal measurement report, the prediction measurement report, and the enhanced measurement report;
in a case that the measurement report is associated with third bit information, the measurement report type corresponding to the measurement report is measurement feedback or the prediction measurement report, and different values of the third bit information indicate the measurement feedback and the prediction measurement report; and
in a case that the measurement report is associated with fourth bit information, the measurement report type corresponding to the measurement report is the normal measurement report or the enhanced measurement report, and different values of the fourth bit information indicate the normal measurement report and the enhanced measurement report.

15. The method according to claim 14, wherein the measurement report type corresponding to the measurement report is one of at least two measurement report types associated with the measurement report configuration.

16. The method according to claim 14, wherein a bit size of the third indication information is associated with the first quantity.

17. The method according to claim 7, wherein the measurement report meets at least one of the following:
in a case that the measurement report type is the prediction measurement report, the measurement report is associated with at least a part of predicted results obtained by performing prediction based on a measurement result; and
in a case that the measurement report type is the enhanced measurement report, the measurement report is associated with all measurement results or a measurement result that meets a first condition.

18. The method according to claim 17, wherein the measurement result that meets the first condition comprises at least one of the following:
a first measurement result greater than a first threshold;
a second measurement equal to the first threshold;
a third measurement results less than a second threshold; and
a fourth measurement equal to the second threshold, wherein
the first threshold is less than the second threshold.

19. A terminal, comprising a processor and a memory, wherein the memory stores a program or an instruction that is executable on the processor, and the processor, upon executing the program or the instruction, is configured to:
send first information to a second device, wherein the first information is used to determine association information of a measurement report, and the association information comprises at least one of the following:
measurement feedback function information indicating a measurement report type;
a first quantity; and
a second quantity, wherein
the measurement report type comprises any one of the following: a normal measurement report, a prediction measurement report, and an enhanced measurement report, the first quantity is determined based on a measurement report configuration, the first quantity indicates at least one of the following: a quantity of target information to be fed back in the measurement report, a maximum quantity of target information to be fed back in the measurement report, and a minimum quantity of target information to be fed back in the measurement report, the second quantity is determined based on the measurement report, the second quantity indicates a quantity of target information in the measurement report, and the target information comprises at least one of information corresponding to a reference signal and channel quality information.

20. A network side device, comprising a processor and a memory, wherein the memory stores a program or an instruction that is executable on the processor, and the program or the instruction is executed by the processor to implement the steps of the measurement feedback processing method according to claim 1.
